(19) United States
(12) Patent Application Publication
(10) Pub. No.: US 2014/0188952 A1
(43) Pub. Date: Jul. 3, 2014

(54) READING DATA WITHOUT AN INDIRECTION LOGICAL REFERENCE IDENTIFIER IN A SYSTEM THAT USES INDIRECTION ACCESS

(71) Applicants: PRAVEEN KILLAMSETTI, Sunnyvale, CA (US); Subramaniam Periagaram, Campbell, CA (US); Aditya Kulkarni, Bangalore, IN (US)

(72) Inventors: PRAVEEN KILLAMSETTI, Sunnyvale, CA (US); Subramaniam Periagaram, Campbell, CA (US); Aditya Kulkarni, Bangalore, IN (US)

(21) Appl. No.: 13/842,997

(22) Filed: Mar. 15, 2013

Related U.S. Application Data
(60) Provisional application No. 61/747,737, filed on Dec. 31, 2012.

(51) Int. Cl. G06F 17/30

(52) U.S. Cl. CPC G06F 17/30132
USPC 707/822

(57) ABSTRACT

A server that caches data in a storage system includes a data access manager that accesses data with a physical location identifier instead of a logical block reference identifier used by a filesystem that manages the cached data. The data access manager provisions a buffer from a pool of buffers maintained by the filesystem, and associates the provisioned buffer with a cache location separate from a buffer cache maintained by the filesystem. The data access manager issues a read for the data with the physical location identifier to obtain the data, and stores the data in the cache location separate from the buffer cache in the provisioned buffer. The data access manager performs a validity check on the obtained data and discards the obtained data when the validity check fails. The data access manager provides access to the buffer to a requesting program.

### RELATED APPLICATION

This application is a nonprovisional application of, and claims the benefit of priority of, U.S. Provisional Patent Application No. 61/747,737, filed Dec. 31, 2012.

### FIELD

Embodiments described are related generally to data cache management, and embodiments described are more particularly related to accessing data without an indirection logical reference identifier in a system that uses indirection access.

### COPYRIGHT NOTICE/PERMISSION

Portions of the disclosure of this patent document can contain material that is subject to copyright protection. The copyright owner has no objection to the reproduction by anyone of the patent document or the patent disclosure as it appears in the Patent and Trademark Office patent file or records, but otherwise reserves all copyright rights whatsoever. The copyright notice applies to all data as described below, and in the accompanying drawings hereto, as well as to any software described below: Copyright © 2013, NetApp, Inc., All Rights Reserved.

### BACKGROUND

Data storage systems manage massive amounts of data. Storage resources of the data storage system store the data, and a server coupled to the storage resources processes access requests (e.g., read and/or write requests) to the data. Data storage systems typically serve data access requests for many clients, including human users, remote computing systems, internal applications, or other sources of access requests. An operating system including a filesystem processes and services the access requests and provides access to the data. Data storage systems typically implement some form of caching to improve efficiency and throughput in the system. The operating system and its filesystem guarantee the validity of the data.

Storage system operating systems can use indirection in the filesystem to manage the data. Indirection offers certain management advantages in referencing data indirectly (with indirection identifiers instead of actual physical data identifiers), which allows use and management of metadata to avoid the need for constant access to the data resources themselves. Such operating systems can also employ other strategies for management such as write tracking to monitor states of data in the system, deduplication to reduce the number of metadata records used to track data accesses, and other strategies. Such strategies offer management advantages in efficient access to data, and increased throughput in servicing access requests, all while guaranteeing that the data accesses are directed to valid data.

However, the different management strategies increase system complexity. Some operations that provide efficiency in one area can have unintended consequences that produce inefficiency in another area. For example, the layers of indirection provide certain management advantages, but can result in slow data reads if a data buffer is already in use within the filesystem. Thus, there are cases in a storage system that uses indirection where an indirection identifier is unavailable to the requesting program. In such circumstances, a storage system operating system can be configured to allow the requesting program to perform access operations using a container for the data instead of the indirection identifier. In other circumstances, the requesting program may simply have to wait until the identifier is available. In either case, the access performance suffers due to the unavailability of the indirection identifier.

### BRIEF DESCRIPTION OF THE DRAWINGS

The following description includes discussion of figures having illustrations given by way of example of implementations of embodiments described. The drawings should be understood by way of example, and not by way of limitation. As used herein, references to one or more “embodiments” are to be understood as describing a particular feature, structure, or characteristic included in at least one implementation. Thus, phrases such as “in one embodiment” or “in an alternate embodiment” appearing herein describe various embodiments and implementations, and do not necessarily all refer to the same embodiment. However, they are also not necessarily mutually exclusive.

FIG. 1 is a block diagram of an embodiment of a server system that uses a private buffer pool to access data without a logical reference identifier.

FIG. 2 is a block diagram of an embodiment of a system with a private buffer pool that accesses data via a data hash separate from a buffer hash maintained by a host operating system.

FIG. 3 is a block diagram of an embodiment of a system where an indirection identifier is used to access data via a filesystem, and a physical identifier is used to bypass the filesystem to access data.

FIG. 4 is a block diagram of an embodiment of a data access manager that can access data without a logical reference identifier.

FIG. 5 is a flow diagram of an embodiment of accessing a buffer bypassing a buffer cache.

FIG. 6A illustrates a network storage system in which a data access manager can be implemented.

FIG. 6B illustrates a distributed or clustered architecture for a network storage system in which a data access manager can be implemented in an alternative embodiment.

FIG. 7 is a block diagram of an illustrative embodiment of an environment of FIGS. 6A and 6B in which a data access manager can be implemented.

FIG. 8 illustrates an embodiment of the storage operating system of FIG. 7 in which a data access manager can be implemented.

Descriptions of certain details and embodiments follow, including a description of the figures, which can depict some or all of the embodiments described below, as well as discussing other potential embodiments or implementations of the inventive concepts presented herein.

### DETAILED DESCRIPTION

As described herein, a server of a storage system includes a data access manager that accesses data with a physical location identifier instead of a logical block reference identifier. The server includes an operating system with a filesystem that manages data access, including caching the data, and referencing and serving the data from cache. The filesystem uses the logical block reference identifier to manage access to the cached data via one or more levels of indirection. The logical block reference identifier can alternatively be referred to as an indirection identifier, and represents the data indirectly; the logical block reference identifier must be mapped to a physical location identifier to access the data. The data access manager can obtain a physical location identifier (e.g., by obtaining and resolving an indirection identifier) that directly references a physical memory location of the data.

The filesystem maintains a pool of buffers, including management of availability of the buffers (e.g., allocation and deallocation of resources for the buffers). The pool of buffers is a group of logical data units of memory used to cache data. The buffers can be managed or maintained through an index or hash created to identify the logical data unit. It will be understood that a buffer is a representation of a physical resources (e.g., storage or memory resources), such as a location in a cache device. The cache can be represented logically as a “hash” representation, which allows logical operations on data access requests prior to committing the requests to the physical resources. From the perspective of locating data and performing checks on the data, typically such operations are performed by an access layer as logical operations on the hash or logical representation of the data. Ultimately the data is stored in, and accessed from, physical locations.

The buffers can be provisioned by initializing the buffer and generating an identifier or hash value for the buffer and allocating resources to manage the buffer. The filesystem typically provisions buffers for use in a buffer cache, which is a caching device that buffers data access requests between the operating system and disk storage. As described herein, the data access manager can provision buffers to a cache location separate from the buffer cache. The separate cache location can be a cache location that is logically separated from the buffer cache in that the same physical device can store the data, and the data access manager provisions and maintains it. Thus, the memory resources are not available for the filesystem to provision for the buffer cache. The data access manager can be considered independent or separate from the filesystem in that the data access manager can execute in parallel to the filesystem, and can access data in parallel to the filesystem without going through the filesystem to access the data.

The data access manager can be considered to bypass the filesystem by performing data access that is not managed by the filesystem and not part of the buffer cache managed by the filesystem. The buffer cache is a caching mechanism used by the filesystem to manage data access. When the data access manager bypasses the filesystem and the buffer cache, the data accessed does not have the guarantees of validity that are provided by the management of the filesystem. Thus, the data access manager provides validity checking of data obtained with a physical location identifier instead of a logical block reference identifier. If the validity check fails, the data access manager discards the data from its cache, which can be referred to as a private cache, in contrast to the buffer cache managed by the filesystem. When the validity test passes, the data access manager can provide access to the data by the requesting program.

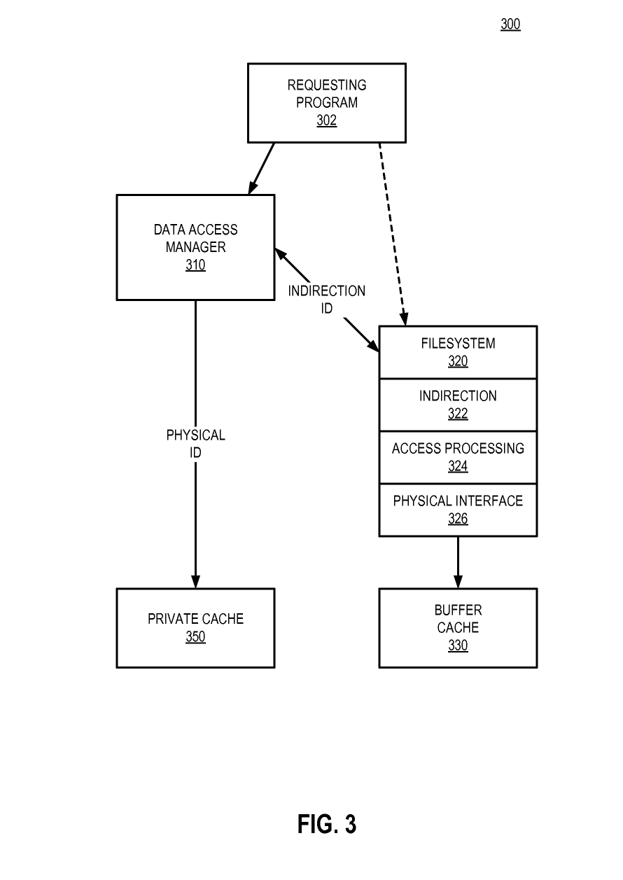

The requesting program is described in more detail below with respect to FIG. 3. Briefly, the requesting program is an application or process, whether a system-level or user-level program, which makes a request for data. The expression “requesting program” or “requesting application” can refer to any standalone software application, as well as threads, processes, or subroutines of a standalone software application. The requesting program will frequently be a service or management entity within the storage system, and interfaces with the data and the operating system of the storage system on behalf of clients of the storage system. The clients can refer to remote programs or devices that are separate from the storage system and access the storage system over a network.

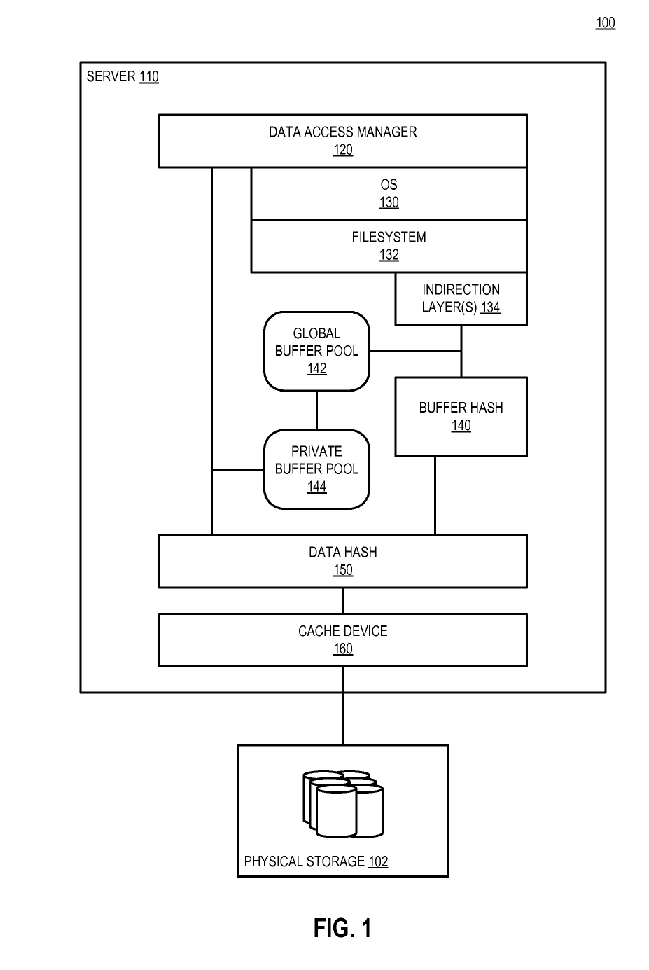

FIG. 1 is a block diagram of an embodiment of a server system that uses a private buffer pool to access data without a logical reference identifier. System 100 is one example of a storage system, including server 110 to receive, process, and service access requests for data stored in storage 102. Server 110 can be any type of storage server or server appliance. Server 110 can be implemented as standalone hardware and/or can be implemented as a virtual device on shared hardware resources. Storage 102 is external to server 110, and is connected to server 110 via network and/or storage interface(s).

Server 110 includes operating system (OS) 130, which manages access to, and use of, hardware and software resources within server 110. In one embodiment, OS 130 receives all data access requests through data access manager 120. Server 110 accesses and performs operations on data via the hardware and software resources. OS 130 includes filesystem 132, which implements rules and policies regarding data access and management. Filesystem 132 provides logical and physical management of the data. Logical management includes how the data is presented to a client. Physical management includes drivers or other physical interface mechanisms used to access the data. Filesystem 132 includes one or more layers of indirection 134, which can be used to manage access to the data.

As is understood by those skilled in the art, disk or nonvolatile storage access is slow relative to operational speeds of computing devices. OS 130 caches data to improve access performance to the data of storage 102. Cache device 160 represents volatile (e.g., random access memory) and/or nonvolatile (e.g., flash) resources used to cache the data. Cache device 160 can be logically and/or physically partitioned to allow different memory resources to be used for different purposes. As illustrated, server 110 includes two logical organizations to manage the buffer resources of cache device 160, global buffer pool 142 and private buffer pool 144.

Global buffer pool 142 represents cache resources maintained by filesystem 142. Thus, the resources of global buffer pool 142 are available to filesystem 132 for caching data from storage 102. Private buffer pool 144 is logically separate from global buffer pool 142 in that when a buffer is provisioned into private buffer pool 144 (provisioned from global buffer pool 142), the buffer is unavailable to filesystem 132. Private buffer pool 144 is maintained by data access manager 120.

Buffer hash 140 represents a logical view of the buffers allocated for caching by filesystem 132. Buffer hash 140 maps a cache location (e.g., a physical memory location) to a buffer in use by filesystem 132. Data hash 150 represents a logical view of all data stored in cache device 160, and could alternatively be referred to as a block data hash. Filesystem 132 applies and enforces data access rules to the data represented in buffer hash 140, and can thus guarantee the validity of the cached data it manages. In one embodiment, data hash 150 simply represents the data without rules related to validity. Data hash 150 can include all data represented in buffer hash 140, as well as other data. In one embodiment, data hash 150 uses a pvbn (physical volume block number) as a hash key for the blocks stored in system 100. In one embodiment, data hash 150 can use pvbn alone as a hash key. Alternatively, data hash 150 can use pvbn in combination with other data as a hash key, for example, using a hash key of <fsid (file space identifier) of aggregate, pvbn>.

In one embodiment, private buffer pool 144 is stored in and accessible by data hash 150, but without guarantees of validity. Rather, data hash 150 can simply provide a physical mapping to all buffers stored in cache device 160, which might have been overwritten or otherwise invalidated. In one embodiment, data access manager 120 operates parallel to and separate from OS 130. In one embodiment, data access manager 120 is implemented as a state machine within OS 130.

In one embodiment, filesystem 132 performs block deduplication of cached data. Block deduplication provides a signature hash for each block to track writes. Filesystem 132 sorts and maintains the signatures, and eliminates duplicate signatures found. Filesystem 132 can track transaction-level data, which results in excessive amounts of metadata, or track blocks of data, which introduces a container bottleneck. The use of transaction-level data becomes prohibitive for an active storage system. However, read operations are performed via container for the block, which is used to access the data when multiple records all refer to the same data buffer. Container operations reduce parallelism, seeing that each record pointing to the same data buffer relies on the same container.

As described herein, data access manager 120 can improve parallelism over container operations by directly accessing the data buffer via private buffer pool 144. Data access manager 120 does not use the container, which is the representation of the data in filesystem 132. In one embodiment, data access manager provisions buffers from global buffer pool 142 to create private buffer pool 144. Data in private buffer pool 144 is represented in data hash 150, and maintained by data access manager 120, but is not part of buffer hash 140. Such a buffer can be referred to as a “stolen buffer.”

In one embodiment, data access manager 120 does not access data via filesystem 132 when using a stolen buffer, and so the data does not have validity checks performed by filesystem 132. Data access manager 120 performs validity checks on the obtained data. For example, data access manager 120 can verify that reference identifiers associated with an obtained buffer match the identifiers used to access the buffer. In one embodiment, data access manager 120 stores the data accessed via private buffer pool 144 as read-only.

The following non-limiting examples illustrate the use of physical location reference identifier instead of a logical reference identifier. It will be understood that different storage systems use different terminology; in places where specific terminology is used in the examples, it will be understood that the example also applies to comparable elements of other storage systems.

In one example, in one embodiment, a program involved in block sharing in the storage system does not have indirection reference information for data. In one embodiment, the indirection reference information refers to a file of a block of data (e.g., an identifier based on <inode, fbn> (indirection node, file block number) information). Such information could be lacking due to the data being in use by a primary filesystem of the storage system, and the filesystem utilizes deduplication. The program can have physical location information for a deduplicated block (e.g., <vvbn, pvbn> (virtual volume block number, physical volume block number) information). The program can share the block to a recipient serviced by the program by issuing a read with the physical location information instead of the logical or indirection reference information. A data access manager can perform a validity check to ensure that the data accessed is still valid.

In another example, in one embodiment, a storage system keeps old data images or snapshots of overwritten data. A storage system can provide access to multiple physical blocks that have been mapped to a logical file reference, but are outdated as overwritten. The system can still provide a comparison between previous versions of the data by returning the physical blocks. Instead of using a container read operation as previously done, as described herein the data access manager can access the data via the physical block identifiers instead of a container read used to resolve the current logical file reference back to the previous data. The data access manager can perform a validity check to ensure that the previous version of the data has not been removed (which would make the physical reference invalid with respect to the sought-after data).

In another example, in one embodiment, the storage system keeps a nonvolatile log (nvlog) of writes to reduce the risk of loss due to power failure. The nvlog can contain operation details, and the log is replayed on system reboot after a failure. The number of operations in an nvlog can be very large, and the system can play back all operations to provide failure recovery. As described herein, a recovery process can access data with physical location references to increase parallelism of data access (where the data is obtained either before or in parallel to an nvlog replay). With the data loaded into cache, the recovery process can finish faster.

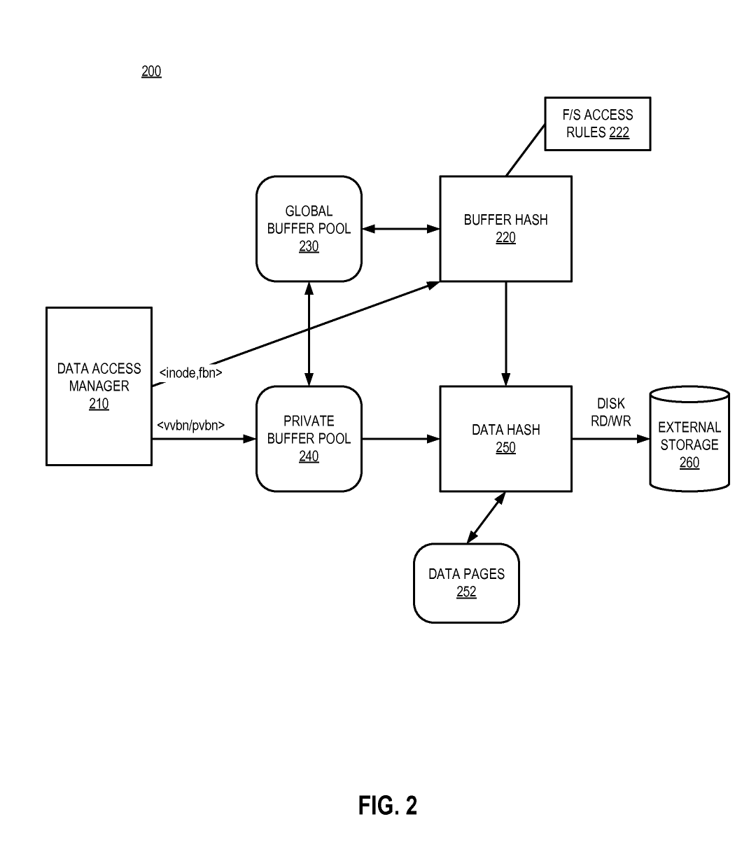

FIG. 2 is a block diagram of an embodiment of a system with a private buffer pool that accesses data via a data hash separate from a buffer hash maintained by a host operating system. System 200 is one example of a storage subsystem, and can be one example of system 100. System 200 provides an example of a logical relationship of data access manager 210, buffer hash 220, and data hash 250. In one embodiment, data hash 250 is a bdata hash or comparable structure. Other illustrations are possible to represent the interrelationships of the components.

Data access manager 210 receives a request to access data from a requesting program or requesting application (not shown). In one embodiment, data access manager 210 receives and processes all data access requests within the storage system. For example, current storage systems can include a type of data access manager, which processes requests to satisfy via data access through the filesystem. However, data access manager 210 includes logic to process requests and access data outside the filesystem.

Thus, in one embodiment, data access manager 210 receives a request and determines that the logical reference identifier associated with the data is known and available to be used in the filesystem. In such a case, data access manager 210 can access buffer hash 220 to access the data with <inode,fbn> or other logical reference identifier. In one embodiment, data access manager 210 receives a request for which the logical reference identifier is unknown and/or unavailable for use in the filesystem. For example, the data may be accessible only via a container operation. In such a case, data access manager 210 can access data hash 250 without going through the filesystem, and without going through buffer hash 220. To access data via data hash 250, data access manager 210 can use a physical reference identifier such as <vvbn,pvbn> values or comparable identifiers.

Data access through the filesystem includes making a request for cached data to buffer hash 220. Buffer hash 220 references data stored in global buffer pool 230. Global buffer pool 230 includes buffers maintained by the filesystem. The filesystem performs operations on the buffers to access and manipulate the data stored referenced in buffer hash 220. Buffer hash 220 is governed by filesystem access rules 222, which includes rules regarding the validity of data in buffer hash 220. In one embodiment, buffer hash 220 references a subset of data of data hash 250. The data in data hash 250 is identified by data pages 252, which indicates all data stored in the cache memory locations, whether or not they have been provisioned for buffer hash 220.

Data pages 252 refer to data read from external storage 260. External storage 260 refers to nonvolatile storage that is outside of the cache of the storage server. Typically the storage is all external to a box or hardware device identified as a storage server, such as a rack of storage. When an application makes a request for data that is not yet cached in the server, the server can read the data from external storage 260 into data hash 250. The filesystem can then provision the data from data hash 250 into buffer hash 220. In one embodiment, the data in data hash 250 is read-only, and writes are performed through buffer hash 220, which can pass through data hash 250 and be read back into the data hash to update the buffers.

As described herein, data access manager 210 provisions buffers from global buffer pool 230 into private buffer pool 240. Such buffers can be referred to as stolen buffers. Stolen buffers are provisioned from global buffer pool 230, which is maintained by the filesystem, but once provisioned they are outside the management of the filesystem. It will be understood that data referenced by stolen buffers in private buffer pool 240 is stored in data hash 250, but not buffer hash 220. Thus, rules 222 do not apply to data in private buffer pool 240. Thus, data access manager 210 provides one or more validity checks of the data to ensure that the data can be validly shared with the requesting program.

Examples of scenarios where a system can use a physical reference identifier instead of a logical reference identifier are provided above. A more detailed look at a deduplication example follows with reference to system 200. Deduplication can be said to use donor blocks, which are the blocks being reused or shared, and recipient blocks, which are the blocks freed up by reusing the donor block. In one embodiment, system 200 uses a deduplication mechanism that tracks all writes in the system, and frees recipient blocks when it determines that duplication exists.

A system that uses deduplication and one or more layers of indirection uses disk information as a signature for block sharing. Thus, the system can use cached blocks that give ranges of addresses, which causes fragmentation with respect to a virtual volume block number. Additionally, deduplication can refer to a block that is used in different files. When a block is referenced by multiple different files (referenced by containers), the container files cannot be read in parallel with traditional processing. However, the data access manager can access different blocks from data hash 250 in parallel without needing to go through the file containers. Thus, the data access does not depend upon the fragmentation or contiguousness of the data blocks when the data access manager performs reads with the physical location reference identifiers.

It will be understood that the cache locations of buffers referenced by private buffer pool 240 are separate from the buffer cache. In one embodiment, data hash 250 is a block data hash that keeps all data pages in the storage system, and data access manager 210 directly accesses data hash 250 for buffers. In one embodiment, data access manager 210 initializes each buffer of private buffer pool 240 from available (e.g., unused) buffers of global buffer pool 230. When data access manager 210 is finished with the read of the data via the stolen buffers, the stolen buffers can be reallocated back into global buffer pool 230. In one embodiment, data access manager 210 initializes stolen buffers with a physical virtual block number or other physical location reference identifier. In one embodiment, the filesystem initializes each buffer in global buffer pool 230 with a virtual volume block number or other indirection or logical reference identifier.

FIG. 3 is a block diagram of an embodiment of a system where an indirection identifier is used to access data via a filesystem, and a physical identifier is used to bypass the filesystem to access data. System 300 provides one example of a storage system in accordance with any embodiment described herein. System 300 can be one example of a storage server in accordance with systems 100 and 200 described above. System 300 more specifically shows requesting program 302, which is a program, application, agent, process, or other source of a request to access data.

In one embodiment, requesting program 302 is a deduplication application. In one embodiment, requesting program 302 is a process that reads snapshot data or legacy images (e.g., prior to changes by a write) of data to view and/or compare current data to previous data in the system. In one embodiment, requesting program 302 is a nonvolatile log (nvlog) application that performs a restore of data. Typically requesting program 302 is required to read data with a container when the logical reference identifier is not available to be used. As explained above, the logical reference identifier can become unavailable with deduplication where multiple files all reference the same data block. A data block is a segment or portion of data that can be represented by a data buffer. More particularly, a data block refers more to the address information of the data, while the data buffer refers to the representation of that cached data block. The snapshot or legacy image applications can lack the logical reference identifier as they deal with data blocks that are no longer the currently active blocks referenced by the logical reference identifier. The nvlogs application generally uses a container because there is a potential that multiple different operations are to be performed on the same data block in the course of a restoration replay of the data. Thus, in each case the requesting application lacks the logical reference identifier.

In many cases such as those identified above, the filesystem represents a volume or file by a container, which prevents the filesystem from running many of its operations. Data access manager 310 can receive data access requests from requesting program 302, and bypass the normal access path to prevent the use of the container read. In one embodiment, requesting program 310 generates an access request, which it passes to data access manager 310. Data access manager 310 can determine that an indirection or logical reference identifier is available for the data associated with the request, and thus pass the request to filesystem 320 with the indirection ID. In one embodiment, access requests where the indirection ID is known can be passed to filesystem 320 without going through data access manager 310. In one embodiment, data access manager 310 passes an indirection ID to filesystem 320 to obtain a physical location identifier.

Filesystem 320 is set up or configured with one or more levels of indirection 322, where the filesystem establishes logical structures to refer to and work on data, rather than using the physical data block itself. In one embodiment, filesystem 320 includes access processing 324 to map indirection IDs to the physical data blocks, as well as applying rules to the access of the data. Physical interface 326 represents the physical mapping, drivers, or other interface mechanisms used to access the physical data blocks. Buffer cache 330 represents a cache that stores the physical data blocks represented by logical reference identifiers.

Data access manager 310 uses physical ID or physical location identifier to bypass buffer cache 330 and directly access data blocks from private cache 350. Private cache 350 is separate from buffer cache, and stores data blocks for which data access manager provisions and manages stolen buffers or a comparable buffer outside the control of filesystem 320.

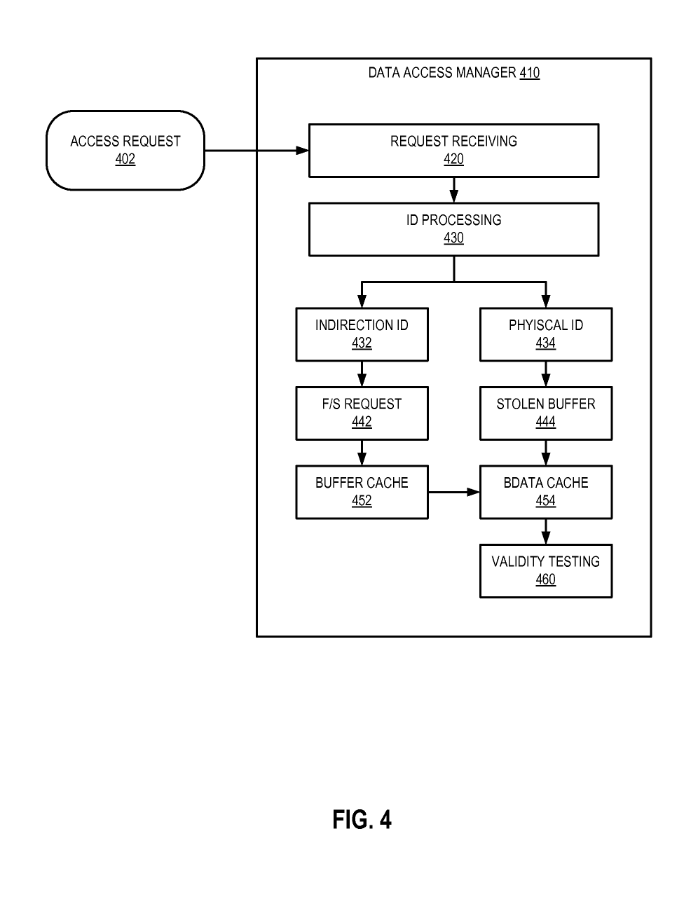

FIG. 4 is a block diagram of an embodiment of a data access manager that can access data without a logical reference identifier. Data access manager 410 represents any data access manager described herein, such as embodiments of data access manager 140, data access manager 210, and data access manager 310. Data access manager 410 improves read performance in a storage system by directly reading the data buffers in the storage system, bypassing a filesystem layer of a storage server. In one embodiment, the data access manager provides the direct read to provide read-only data access, and performs validity checks on the data prior to providing the access. The validity checks can ensure that the data is not stale or that the identifier points to active data rather than pointing to data from an inactive data location/address.

Data access manager 410 receives access request 402 from a requesting program. Access request 402 can include a virtual volume block number (vvbn) or comparable logical file reference ID, or the request can be processed to identify a vvbn. Request receiving 420 represents logic of data access manager 410 to receive and processing access request 402. In one embodiment, request receiving logic 420 enables data access manager 410 to determine that a request is associated with a particular vvbn.

ID processing 430 represents logic of data access manager 410 that enables data access manager 410 to determine whether the system can use a logical file reference ID to access the data, or instead should use a physical reference ID. ID processing 430 can make a determination, for example, by determining what application generated the request. ID processing 430 can access a log of data in the buffer cache and/or a log of deduplication information to determine whether a container read is required for accessing the data.

If a logical file reference ID or indirection ID 432 is available, ID processing can send a filesystem (F/S) request 442, which accesses the data via buffer cache 452. The data stored in buffer cache 452 can also be represented in bdata cache 454. If the logical file reference ID is not available, data access manager 410 can obtain a physical location ID 434 to use to access the data.

When using a physical location ID 434, data access manager 410 can allocate and initialize stolen buffer 444. In one embodiment, data access manager initializes stolen buffer 444 with a vvbn associated with access request 402. In one embodiment, data access manager 410 obtains physical ID 434 via the vvbn, for example, by going through a container indirect process. With a physical location ID (e.g., pvbn information), data access manager 410 can issue a direct read of the data. In one embodiment, once the read is done, data access manager 410 places the data in a private buffer of bdata hash 454, or a hash which keeps all data pages in the system. In one embodiment, data access manager 410 hashes the data by pvbn and aggregate ID.

In one embodiment, the data is read-only when accessed through a physical reference ID. Data access manager 410 performs one or more checks to ensure the data is valid. In one embodiment, data access manager 410 checks to see if the physical location ID is stale, for example, by consulting an active data map. In one embodiment, data access manager 410 obtains a pvbn from a container indirect and checks against a pvbn used for issuing the direct read to see if the two IDs match. Other checks can also be performed. If a validity check fails, data access manager 410 discards the data.

Above checks not required if we are trying to read data from snapshot as they are read-only always. We just need to ensure snapshot is not deleted during the read.

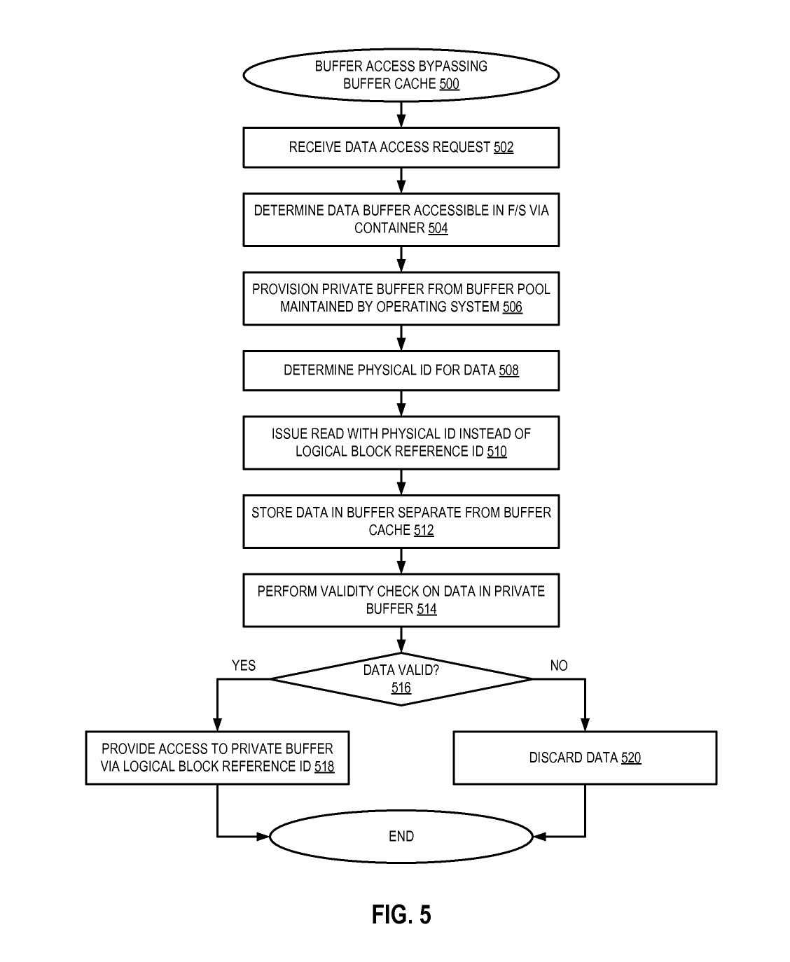

FIG. 5 is a flow diagram of an embodiment of process 500 for accessing a buffer bypassing a buffer cache. A data access manager receives a data access request from a requesting program, block 502. In one embodiment, the data access manager includes logic to determine whether the data buffer is accessible in the filesystem via a container, or whether an indirection identifier is available to access the data, block 504. The read performance of an access with the indirection identifier is better than the read performance using a container. If only the container read is available to the data access manager, it can determine to access the data directly with a physical location identifier instead of the indirection identifier.

Thus, the data access manager provisions a private buffer or stolen buffer from a buffer pool maintained by the operating system and used by the filesystem to cache and access the data, block 506. In one embodiment, the data access manager provisions the private buffer with an indirection identifier associated with a container used by the filesystem to access the data. In one embodiment, the data access manager uses the indirection identifier and/or the container to determine a physical identifier for the data, block 508. With the physical identifier for the data, the data access manager can issue a read for the data using the physical identifier instead of accessing the data via the buffer cache using the logical block reference identifier, block 510.

The data access manager stores the obtained data in the private buffer in a cache separate from the buffer cache maintained by the filesystem, block 512. The data access manager performs one or more validity checks on the data stored in the private buffer, block 514. If the data is valid, block 516 YES branch, the data access manager provides access to the requesting program to the private buffer via the logical block reference identifier, block 518. Otherwise, if the data is invalid, block 516 NO branch, the data access manager discards the data, block 520.

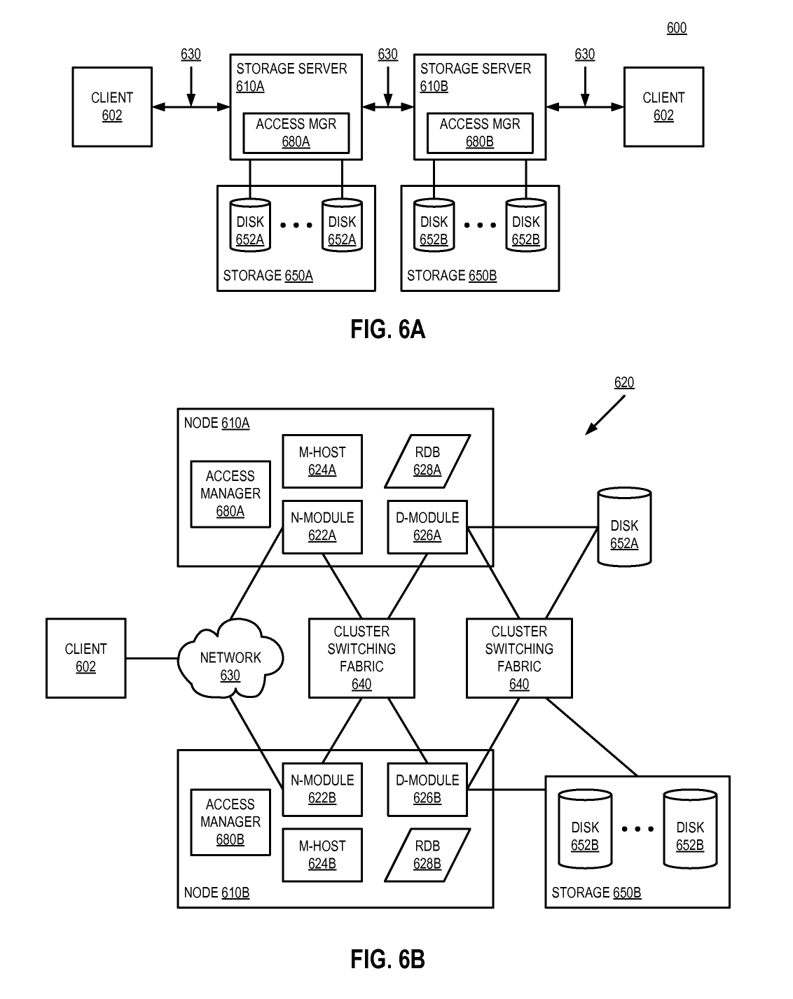

FIG. 6A illustrates a network storage system in which a data access manager can be implemented. Storage servers 610 (storage servers 610A, 610B) each manage multiple storage units 650 (storage 650A, 650B) that include mass storage devices. These storage servers provide data storage services to one or more clients 602 through a network 630. Network 630 can be, for example, a local area network (LAN), wide area network (WAN), metropolitan area network (MAN), global area network such as the Internet, a Fibre Channel fabric, or any combination of such interconnects. Each of clients 602 can be, for example, a conventional personal computer (PC), server-class computer, workstation, handheld computing or communication device, or other special or general purpose computer.

Storage of data in storage units 650 is managed by storage servers 610 which receive and respond to various read and write requests from clients 602, directed to data stored in or to be stored in storage units 650. Storage units 650 constitute mass storage devices which can include, for example, flash memory, magnetic or optical disks, or tape drives, illustrated as disks 652 (652A, 652B). Storage devices 652 can further be organized into arrays (not illustrated) implementing a Redundant Array of Inexpensive Disks/Devices (RAID) scheme, whereby storage servers 610 access storage units 650 using one or more RAID protocols known in the art.

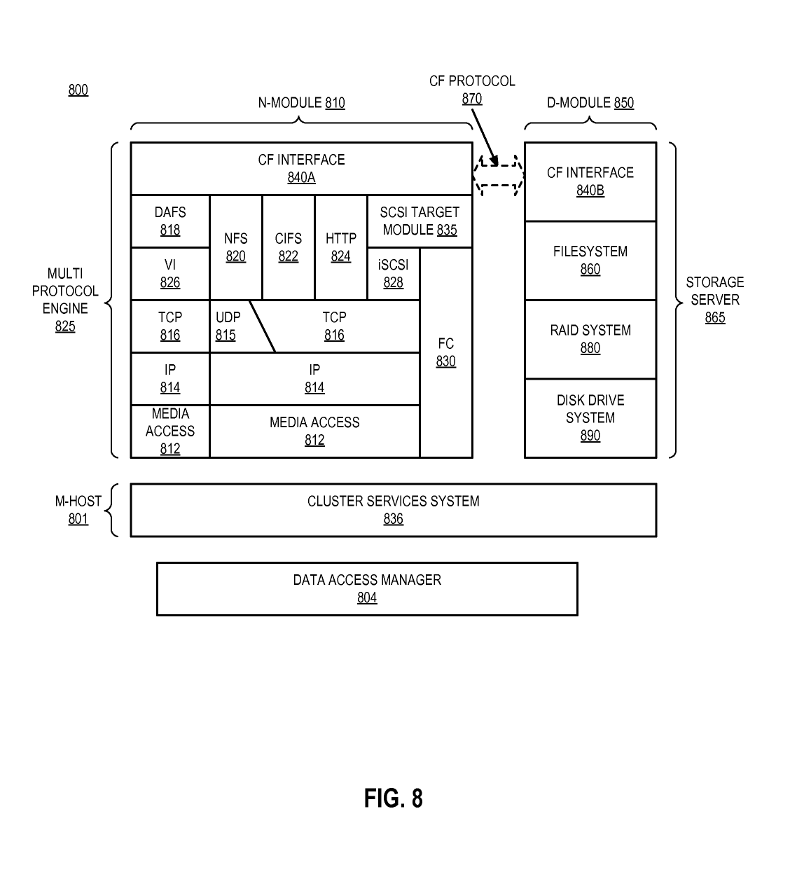

Storage servers 610 can provide file-level service such as used in a network-attached storage (NAS) environment, block-level service such as used in a storage area network (SAN) environment, a service which is capable of providing both file-level and block-level service, or any other service capable of providing other data access services. Although storage servers 610 are each illustrated as single units in FIG. 6A, a storage server can, in other embodiments, constitute a separate network element or module (an “N-module”) and disk element or module (a “D-module”). In one embodiment, the D-module includes storage access components for servicing client requests. In contrast, the N-module includes functionality that enables client access to storage access components (e.g., the D-module), and the N-module can include protocol components, such as Common Internet File System (CIFS), Network File System (NFS), or an Internet Protocol (IP) module, for facilitating such connectivity. Details of a distributed architecture environment involving D-modules and N-modules are described further below with respect to FIG. 6B and embodiments of a D-module and an N-module are described further below with respect to FIG. 8.

In one embodiment, storage servers 610 are referred to as network storage subsystems. A network storage subsystem provides networked storage services for a specific application or purpose, and can be implemented with a collection of networked resources provided across multiple storage servers and/or storage units.

In the embodiment of FIG. 6A, one of the storage servers (e.g., storage server 610A) functions as a primary provider of data storage services to client 602. Data storage requests from client 602 are serviced using disks 652A organized as one or more storage objects. A secondary storage server (e.g., storage server 610B) takes a standby role in a mirror relationship with the primary storage server, replicating storage objects from the primary storage server to storage objects organized on disks of the secondary storage server (e.g., disks 650B). In operation, the secondary storage server does not service requests from client 602 until data in the primary storage object becomes inaccessible such as in a disaster with the primary storage server, such event considered a failure at the primary storage server. Upon a failure at the primary storage server, requests from client 602 intended for the primary storage object are serviced using replicated data (i.e. the secondary storage object) at the secondary storage server.

It will be appreciated that in other embodiments, network storage system 600 can include more than two storage servers. In these cases, protection relationships can be operative between various storage servers in system 600 such that one or more primary storage objects from storage server 610A can be replicated to a storage server other than storage server 610B (not shown in this figure). Secondary storage objects can further implement protection relationships with other storage objects such that the secondary storage objects are replicated, e.g., to tertiary storage objects, to protect against failures with secondary storage objects. Accordingly, the description of a single-tier protection relationship between primary and secondary storage objects of storage servers 610 should be taken as illustrative only.

In one embodiment, system 600 includes data access manager 680 (680A, 680B) server-side. In an embodiment wherein 600 accesses data via a logical reference identifier, access managers 680 include logic that allows system 600 to access data without the logical reference identifier. Instead, access managers 680 can access the data via a physical identifier.

FIG. 6B illustrates a distributed or clustered architecture for a network storage system in which a data access manager can be implemented in an alternative embodiment. System 620 can include storage servers implemented as nodes 610 (nodes 610A, 610B) which are each configured to provide access to storage devices 652. In FIG. 6B, nodes 610 are interconnected by a cluster switching fabric 640, which can be embodied as an Ethernet switch.

Nodes 610 can be operative as multiple functional components that cooperate to provide a distributed architecture of system 620. To that end, each node 610 can be organized as a network element or module (N-module 622A, 622B), a disk element or module (D-module 626A, 626B), and a management element or module (M-host 624A, 624B). In one embodiment, each module includes a processor and memory for carrying out respective module operations. For example, N-module 622 can include functionality that enables node 610 to connect to client 602 via network 630 and can include protocol components such as a media access layer, Internet Protocol (IP) layer, Transport Control Protocol (TCP) layer, User Datagram Protocol (UDP) layer, and other protocols known in the art.

In contrast, D-module 626 can connect to one or more storage devices 652 via cluster switching fabric 640 and can be operative to service access requests on devices 650. In one embodiment, the D-module 626 includes storage access components such as a storage abstraction layer supporting multi-protocol data access (e.g., Common Internet File System protocol, the Network File System protocol, and the Hypertext Transfer Protocol), a storage layer implementing storage protocols (e.g., RAID protocol), and a driver layer implementing storage device protocols (e.g., Small Computer Systems Interface protocol) for carrying out operations in support of storage access operations. In the embodiment shown in FIG. 6B, a storage abstraction layer (e.g., file system) of the D-module divides the physical storage of devices 650 into storage objects. Requests received by node 610 (e.g., via N-module 622) can thus include storage object identifiers to indicate a storage object on which to carry out the request.

Also operative in node 610 is M-host 624 which provides cluster services for node 610 by performing operations in support of a distributed storage system image, for instance, across system 620. M-host 624 provides cluster services by managing a data structure such as a relational database (RDB) 628 (RDB 628A, RDB 628B) which contains information used by N-module 622 to determine which D-module 626 “owns” (services) each storage object. The various instances of RDB 628 across respective nodes 610 can be updated regularly by M-host 624 using conventional protocols operative between each of the M-hosts (e.g., across network 630) to bring them into synchronization with each other. A client request received by N-module 622 can then be routed to the appropriate D-module 626 for servicing to provide a distributed storage system image.

As described above, system 600 includes data access manager 680 (680A, 680B) server-side. In an embodiment wherein 600 accesses data via a logical reference identifier, access managers 680 include logic that allows system 600 to access data without the logical reference identifier. Instead, access managers 680 can access the data via a physical identifier.

It will be noted that while FIG. 6B shows an equal number of N- and D-modules constituting a node in the illustrative system, there can be different number of N- and D-modules constituting a node in accordance with various embodiments. For example, there can be a number of N-modules and D-modules of node 610A that does not reflect a one-to-one correspondence between the N- and D-modules of node 610B. As such, the description of a node comprising one N-module and one D-module for each node should be taken as illustrative only.

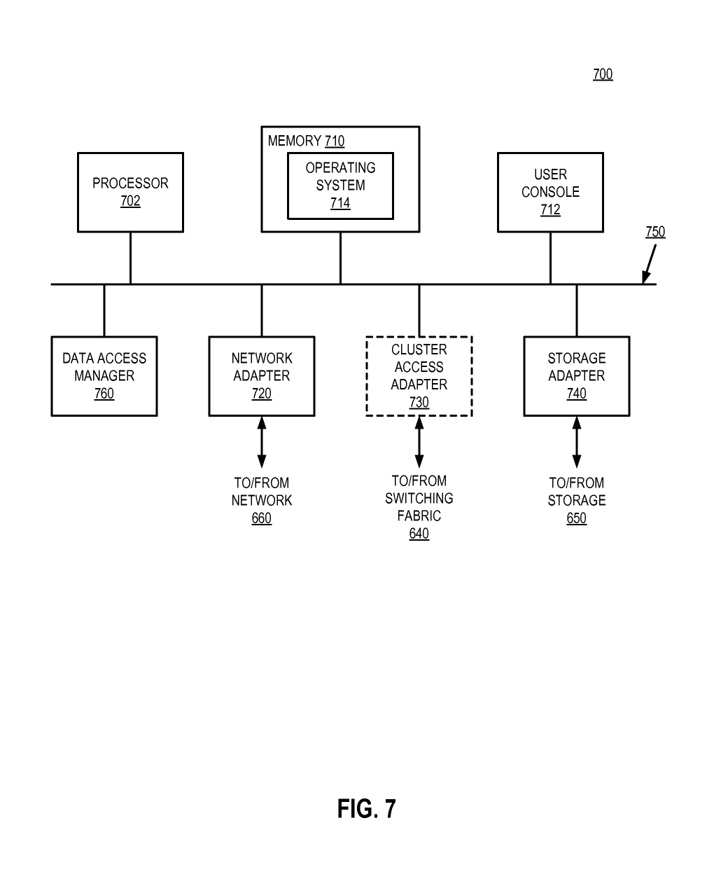

FIG. 7 is a block diagram of an embodiment of a storage server, such as storage servers 610A and 610B of FIG. 6A and 6B in which a data access manager can be implemented. As illustrated, the storage server is embodied as a general or special purpose computer 700 including a processor 702, a memory 710, a network adapter 720, a user console 712 and a storage adapter 740 interconnected by a system bus 750, such as a convention Peripheral Component Interconnect (PCI) bus.

Memory 710 includes storage locations addressable by processor 702, network adapter 720 and storage adapter 740 for storing processor-executable instructions and data structures associated with a multi-tiered cache with a virtual storage appliance. A storage operating system 714, portions of which are typically resident in memory 710 and executed by processor 702, functionally organizes the storage server by invoking operations in support of the storage services provided by the storage server. It will be apparent to those skilled in the art that other processing means can be used for executing instructions and other memory means, including various computer readable media, can be used for storing program instructions pertaining to the inventive techniques described herein. It will also be apparent that some or all of the functionality of the processor 702 and executable software can be implemented by hardware, such as integrated currents configured as programmable logic arrays, ASICs, and the like.

Network adapter 720 comprises one or more ports to couple the storage server to one or more clients over point-to-point links or a network. Thus, network adapter 720 includes the mechanical, electrical and signaling circuitry needed to couple the storage server to one or more client over a network. Each client can communicate with the storage server over the network by exchanging discrete frames or packets of data according to pre-defined protocols, such as TCP/IP.

Storage adapter 740 includes a plurality of ports having input/output (I/O) interface circuitry to couple the storage devices (e.g., disks) to bus 750 over an I/O interconnect arrangement, such as a conventional high-performance, FC or SAS (Serial-Attached SCSI (Small Computer System Interface)) link topology. Storage adapter 740 typically includes a device controller (not illustrated) comprising a processor and a memory for controlling the overall operation of the storage units in accordance with read and write commands received from storage operating system 714. As used herein, data written by a device controller in response to a write command is referred to as “write data,” whereas data read by device controller responsive to a read command is referred to as “read data.”

User console 712 enables an administrator to interface with the storage server to invoke operations and provide inputs to the storage server using a command line interface (CLI) or a graphical user interface (GUI). In one embodiment, user console 712 is implemented using a monitor and keyboard.

In one embodiment, computing device 700 includes data access manager 760. While shown as a separate component, in one embodiment, data access manager 760 is part of other components of computer 700. In an embodiment, operating system 714 manages data access via a logical reference identifier, and data access manager 760 includes logic that allows access to data without the logical reference identifier. Instead, data access manager 760 can access the data via a physical reference identifier.

When implemented as a node of a cluster, such as cluster 620 of FIG. 6B, the storage server further includes a cluster access adapter 730 (shown in phantom) having one or more ports to couple the node to other nodes in a cluster. In one embodiment, Ethernet is used as the clustering protocol and interconnect media, although it will be apparent to one of skill in the art that other types of protocols and interconnects can by utilized within the cluster architecture.

FIG. 8 is a block diagram of a storage operating system 800, such as storage operating system 714 of FIG. 7, in which a data access manager can be implemented. The storage operating system comprises a series of software layers executed by a processor, such as processor 702 of FIG. 7, and organized to form an integrated network protocol stack or, more generally, a multi-protocol engine 825 that provides data paths for clients to access information stored on the storage server using block and file access protocols.

Multi-protocol engine 825 includes a media access layer 812 of network drivers (e.g., gigabit Ethernet drivers) that interface with network protocol layers, such as the IP layer 814 and its supporting transport mechanisms, the TCP layer 816 and the User Datagram Protocol (UDP) layer 815. The different instances of access layer 812, IP layer 814, and TCP layer 816 are associated with two different protocol paths or stacks. A file system protocol layer provides multi-protocol file access and, to that end, includes support for the Direct Access File System (DAFS) protocol 818, the NFS protocol 820, the CIFS protocol 822 and the Hypertext Transfer Protocol (HTTP) protocol 824. A VI (virtual interface) layer 826 implements the VI architecture to provide direct access transport (DAT) capabilities, such as RDMA, as required by the DAFS protocol 818. An iSCSI driver layer 828 provides block protocol access over the TCP/IP network protocol layers, while a FC driver layer 830 receives and transmits block access requests and responses to and from the storage server. In certain cases, a Fibre Channel over Ethernet (FCoE) layer (not shown) can also be operative in multi-protocol engine 825 to receive and transmit requests and responses to and from the storage server. The FC and iSCSI drivers provide respective FC- and iSCSI-specific access control to the blocks and, thus, manage exports of luns (logical unit numbers) to either iSCSI or FCP or, alternatively, to both iSCSI and FCP when accessing blocks on the storage server.

The storage operating system also includes a series of software layers organized to form a storage server 865 that provides data paths for accessing information stored on storage devices. Information can include data received from a client, in addition to data accessed by the storage operating system in support of storage server operations such as program application data or other system data. Preferably, client data can be organized as one or more logical storage objects (e.g., volumes) that comprise a collection of storage devices cooperating to define an overall logical arrangement. In one embodiment, the logical arrangement can involve logical volume block number (vbn) spaces, wherein each volume is associated with a unique vbn.

File system 860 implements a virtualization system of the storage operating system through the interaction with one or more virtualization modules (illustrated as a SCSI target module 835). SCSI target module 835 is generally disposed between drivers 828, 830 and file system 860 to provide a translation layer between the block (lun) space and the file system space, where luns are represented as blocks. In one embodiment, file system 860 implements a WAFL (write anywhere file layout) file system having an on-disk format representation that is block-based using, e.g., 4 kilobyte (KB) blocks and using a data structure such as index nodes or indirection nodes (“inodes”) to identify files and file attributes (such as creation time, access permissions, size and block location). File system 860 uses files to store metadata describing the layout of its file system, including an inode file, which directly or indirectly references (points to) the underlying data blocks of a file.

Operationally, a request from a client is forwarded as a packet over the network and onto the storage server where it is received at a network adapter. A network driver such as layer 812 or layer 830 processes the packet and, if appropriate, passes it on to a network protocol and file access layer for additional processing prior to forwarding to file system 860. There, file system 860 generates operations to load (retrieve) the requested data from the disks if it is not resident “in core”, i.e., in memory 710. If the information is not in memory, file system 860 accesses the inode file to retrieve a logical vbn and passes a message structure including the logical vbn to the RAID system 880. There, the logical vbn is mapped to a disk identifier and device block number (disk, dbn) and sent to an appropriate driver of disk driver system 890. The disk driver accesses the dbn from the specified disk and loads the requested data block(s) in memory for processing by the storage server. Upon completion of the request, the node (and operating system 800) returns a reply to the client over the network.

It should be noted that the software “path” through the storage operating system layers described above needed to perform data storage access for the client request received at the storage server adaptable to the teachings of the invention can alternatively be implemented in hardware. That is, in an alternate embodiment of the invention, a storage access request data path can be implemented as logic circuitry embodied within a field programmable gate array (FPGA) or an application specific integrated circuit (ASIC). This type of hardware embodiment increases the performance of the storage service provided by the storage server in response to a request issued by a client. Moreover, in another alternate embodiment of the invention, the processing elements of adapters 720, 740 can be configured to offload some or all of the packet processing and storage access operations, respectively, from processor 702, to increase the performance of the storage service provided by the storage server. It is expressly contemplated that the various processes, architectures and procedures described herein can be implemented in hardware, firmware or software.

When implemented in a cluster, data access components of the storage operating system can be embodied as D-module 850 for accessing data stored on disk. In contrast, multi-protocol engine 825 can be embodied as N-module 810 to perform protocol termination with respect to a client issuing incoming access over the network, as well as to redirect the access requests to any other N-module in the cluster. A cluster services system 836 can further implement an M-host (e.g., M-host 801) to provide cluster services for generating information sharing operations to present a distributed file system image for the cluster. For instance, media access layer 812 can send and receive information packets between the various cluster services systems of the nodes to synchronize the replicated databases in each of the nodes.

In addition, a cluster fabric (CF) interface module 840 (CF interface modules 840A, 840B) can facilitate intra-cluster communication between N-module 810 and D-module 850 using a CF protocol 870. For instance, D-module 850 can expose a CF application programming interface (API) to which N-module 810 (or another D-module not shown) issues calls. To that end, CF interface module 840 can be organized as a CF encoder/decoder using local procedure calls (LPCs) and remote procedure calls (RPCs) to communicate a file system command between D-modules residing on the same node and remote nodes, respectively.

In one embodiment, data access manager 804 enables access to data without a logical reference identifier. Operating system 800 can support use of indirection, including potentially multiple levels of indirection. In such an implementation, data access is performed via a logical reference identifier through the indirection level(s). In some cases the indirection identifier is unavailable or will result in poor performance. Instead of using the logical reference identifier, data access manager 804 includes logic that enables access provisioning a private buffer to access data without the logical reference identifier.

As used herein, the term “storage operating system” generally refers to the computer-executable code operable on a computer to perform a storage function that manages data access and can implement data access semantics of a general purpose operating system. The storage operating system can also be implemented as a microkernel, an application program operating over a general-purpose operating system, or as a general-purpose operating system with configurable functionality, which is configured for storage applications as described herein.

As used herein, instantiation refers to creating an instance or a copy of a source object or source code. The source code can be a class, model, or template, and the instance is a copy that includes at least some overlap of a set of attributes, which can have different configuration or settings than the source. Additionally, modification of an instance can occur independent of modification of the source.

Flow diagrams as illustrated herein provide examples of sequences of various process actions. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

Various operations or functions are described herein, which can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communications interface to send data via the communications interface. A machine readable medium or computer readable medium can cause a machine to perform the functions or operations described, and includes any mechanism that provides (i.e., stores and/or transmits) information in a form accessible by a machine (e.g., computing device, electronic system, or other device), such as via recordable/non-recordable storage media (e.g., read only memory (ROM), random access memory (RAM), magnetic disk storage media, optical storage media, flash memory devices, or other storage media) or via transmission media (e.g., optical, digital, electrical, acoustic signals or other propagated signal). A communication interface includes any mechanism that interfaces to any of a hardwired, wireless, optical, or other medium to communicate to another device, such as a memory bus interface, a processor bus interface, an Internet connection, a disk controller. The communication interface can be configured by providing configuration parameters and/or sending signals to prepare the communication interface to provide a data signal describing the software content.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to the disclosed embodiments and implementations without departing from their scope. Therefore, the illustrations and examples herein should be construed in an illustrative, and not a restrictive sense.

What is claimed is:

1. A method for accessing data in a storage system:
provisioning a buffer from a pool of buffers maintained by a filesystem of the storage system, the provisioning including provisioning the buffer by a data access manager independent of the filesystem to bypass the filesystem;
issuing a read from the data access manager for the data with a physical location identifier to obtain the data independent of referencing a logical block reference identifier;
storing the data in the provisioned buffer in a cache location separate from a buffer cache maintained by the filesystem; and
providing access to the buffer via the logical block reference identifier to a requesting program.

2. The method of claim 1, wherein initializing the buffer with the logical block reference identifier comprises initializing the buffer with a virtual volume block number.

3. The method of claim 1, wherein the physical location identifier comprises a physical volume block number.

4. The method of claim 1, wherein storing the data in the buffer in the cache location separate from the buffer cache comprises storing the data in the buffer in a block data hash that keeps all data pages in the storage system.

5. The method of claim 1, wherein storing the data in the buffer in the cache location comprises storing the data in the buffer as a read-only copy of the data.

6. The method of claim 1, further comprising:
performing a validity check on the obtained data; and
discarding the obtained data when the validity check fails.

7. The method of claim 6, wherein performing the validity check comprises determining from an active data map whether the physical location identifier is stale.

8. The method of claim 6, wherein performing the validity check comprises
obtaining a filesystem physical location identifier from an indirection node of a container for the data from the filesystem; and
comparing the filesystem physical location identifier with the physical location identifier used to obtain the data to determine if the identifiers match.

9. A server device comprising:
a hardware interface to access storage devices;
a cache device to cache access transactions for data on the storage devices, the cache device allocated and managed as a pool of buffers for a buffer hash maintained by a filesystem of an operating system of the server device;
a data access manager separate from the filesystem, the data access manager to provision a buffer from the pool of buffers, issue a read for the data with a physical location identifier to obtain the data instead of with a logical block reference identifier used by the filesystem, store the data in a data hash separate from the buffer hash including associating the provisioned buffer with the data, and provide access to the buffer to a requesting program.

10. The server device of claim 9, wherein the logical block reference identifier comprises a virtual volume block number.

11. The server device of claim 9, wherein the physical location identifier comprises a physical volume block number.

12. The server device of claim 9, wherein the data hash comprises block data hash that keeps all data pages in the storage system.

13. The server device of claim 9, wherein the data access manager is to store the data in the buffer as a read-only copy of the data.

14. The server device of claim 9, wherein the data access manager is to further
obtain a filesystem physical location identifier from an indirection node of a container for the data from the filesystem; and
compare the filesystem physical location identifier with the physical location identifier used to obtain the data to determine if the identifiers match.

15. The server device of claim 9, wherein the data access manager is to further
perform a validity check on the obtained data; and
discard the obtained data when the validity check fails.

16. An article of manufacture comprising a computer-readable storage medium having content stored thereon, which when accessed by a server device causes the server device to perform operations including:
provisioning a buffer from a pool of buffers maintained by a filesystem of the storage system, the provisioning including provisioning the buffer by a data access manager independent of the filesystem to bypass the filesystem;
issuing a read from the data access manager for the data with a physical location identifier to obtain the data independent of referencing a logical block reference identifier;
storing the data in the provisioned buffer in a cache location separate from a buffer cache maintained by the filesystem; and
providing access to the buffer to a requesting program.

17. The article of manufacture of claim 16, wherein the content for initializing the buffer with the logical block reference identifier comprises content for initializing the buffer with a virtual volume block number.

18. The article of manufacture of claim 16, wherein the physical location identifier comprises a physical volume block number.

19. The article of manufacture of claim 16, wherein the content for storing the data in the buffer in the cache location separate from the buffer cache comprises content for storing the data in the buffer in a block data hash that keeps all data pages in the storage system.

20. The article of manufacture of claim 16, wherein the content for storing the data in the buffer in the cache location comprises content for storing the data in the buffer as a read-only copy of the data.

21. The article of manufacture of claim 16, wherein the content for performing the validity check comprises content for
performing a validity check on the obtained data; and
discarding the obtained data when the validity check fails.

22. The article of manufacture of claim 16, wherein the content for performing the validity check comprises content for
obtaining a filesystem physical location identifier from an indirection node of a container for the data from the filesystem; and
comparing the filesystem physical location identifier with the physical location identifier used to obtain the data to determine if the identifiers match.
